(19) United States
(12) Patent Application Publication
(10) Pub. No.: US 2015/0292239 A1
(43) Pub. Date: Oct. 15, 2015

(54) Self-Locking Lockbox System and Method

(71) Applicants: Kwan Yuen Ng, El Monte, CA (US); Sarah Ng, EI Monte, CA (US); Tsz Yueng Chan, EI Monte, CA (US); Caron Ng, El Monte, CA (US)

(72) Inventors: Kwan Yuen Ng, El Monte, CA (US); Sarah Ng, EI Monte, CA (US); Tsz Yueng Chan, EI Monte, CA (US); Caron Ng, El Monte, CA (US)

(21) Appl. No.: 14/248,605

(22) Filed: Apr. 9, 2014

(51) Int. Cl. E05B 37/00; E05B 65/52

(52) U.S. Cl. CPC E05B 37/00; E05B 65/52

(57) ABSTRACT

The present invention generally relates to lockboxes. More particularly, the invention relates to a lockbox which is designed to self-lock such that an additional input or locking action is not required to lock the lockbox when closed.

### FIELD OF THE INVENTION

The present invention generally relates to lockboxes. More particularly, the invention relates to a lockbox which is designed to self-lock such that an additional locking action is not required by the user to lock the lockbox, when closed.

### BACKGROUND

Lockboxes are commonly used in the real estate sales industry to provide a means for a large number of salesmen to conveniently gain access to locked buildings. A typical lockbox includes an inner repository that can be used to store a key to a building. The inner repository of the lockbox can be accessed by opening a lockable door attached to the lockbox. A combination locking mechanism can be used to enable the door to be lockable and limit access to the inner repository. In this manner, individuals having the combination to the combination lock will have access to the key in the inner repository, thereby having access to the locked building.

A number of lockbox designs have been developed. U.S. Pat. No. 5,815,557 issued to Larson discloses a secure entry system that makes use of radio transmissions to communicate with locks, keys, and related components throughout the system. The radio transmissions can be made using a paging system, a cellular telephone system, or any other RF carrier. Some embodiments employ a cellular telephone in lieu of an electronic key. Others integrate a paging receiver within an electronic key to provide a unit with dual functionality. The system is illustrated with reference to exemplary application in the industrial site security, real estate lockbox, and transportation fields. A homeowner key allows the homeowner greater oversight and involvement. The key includes a privacy feature, enabling the homeowner to disable the lockbox for a predetermined period if privacy is desired.

U.S. Pat. No. 4,727,368 issued to Larson, et al. describes real estate lockbox and key designs which provide a variety of operational features. Also disclosed is a comprehensive system that allows real estate boards and agencies to efficiently manage their lockbox operations. Features provided by the system include the ability to record all accesses to all lockboxes; transfer all or part of such records from the lockboxes to the real estate agency or board; organize and review such records at the agency or board offices; disable operation of various lockboxes during certain hours of the day; facilitate operation of lockboxes that are mounted in awkward or poorly lit locations; limit lockbox accesses to pre-selected agents, agencies or boards; and record diagnostic information with each operation of a lockbox or key.

U.S. Pat. No. 6,813,912 issued to Ng, et al. describes a secure lockbox that includes an interior key lock controlling access to the mechanism for setting and changing the combination for the lock controlling access to the interior storage compartment of the lockbox. A second key lock controls the attachment bail of the lockbox, preventing unauthorized removal of the lockbox. The two key locks may be identically keyed. In a variant of the invention, a second combination lock controls the attachment bail instead of a key lock. Resilient coverings are provided for the attachment bail and the sides of the lockbox body to prevent damage to buildings and fixtures. A chain is provided to secure the door of the lockbox to the body. A slide latch having non-slip features is controlled by the door's combination lock and engages an edge of the door opening to secure the door opening.

While various improvements have been made to these traditional lockboxes over the years, certain disadvantages still remain. For example, once the lockbox is open by way of entering a combination into the combination locking mechanism the lockbox will remain open until the user of the lockbox has reentered the combination into the combination lock to enable the door to lock. Moreover, it is desirable to be able to close the lockable door whereby when the lockable door is closed the lockbox is locked without reentry of a combination. Additionally, often times the user forgets their combination or forgets to reenter their combination to relock the door. When the combination is not reentered the door is not able to fully close and lock. This enables anyone to open the lockbox and retrieve the continents.

Given the deficiencies described above, there exists an unfulfilled need for an improved lockbox system that addresses the various disadvantages inherent to lockboxes found in the prior art.

### SUMMARY

According to the exemplary embodiments of the present invention, a mechanical lockbox system is provided that is smartly designed such a lockable door is provided such that when the lockable door of the lockbox is pushed closed the lockable door is locked such that an additional locking action or reentry of a combination is not required to lock the lockbox when closed.

According to one embodiment of the present invention, the lockbox door consists of a body and a lockable door whereby the lockable door includes a combination locking mechanism and when the lockable door is opened the lockable door exposes an inner repository within the body. Furthermore, the lockable door includes a latching system that enables the lockable door to open by applying pressure to the locking end of the lockable door.

According to another embodiment, the inventive lockable door includes a locking latch securing mechanism that will temporarily hold the latching system such that when the latching system is operated to open the locking latch securing mechanism temporally holds the locking latch such that the lockable door clears the body and opens.

### BRIEF DESCRIPTION OF THE DRAWINGS

The accompanying drawings, which are incorporated into and constitute a part of this specification, illustrate one or more embodiments, and together with the detailed description, serve to explain the principles and implementation of the invention. Additionally when reviewing the drawings as a whole, phases of the self-locking lockbox are disclosed and such conditions include a closed and locked condition, unlocked condition and an open condition. The closed configuration is illustrated in FIGS. 1 and 2, the unlocked configuration is represented in FIGS. 3 and 4 and the open configuration is illustrated in FIG. 5.

FIG. 1 illustrates an exemplary embodiment of a lockbox according to the present invention.

FIG. 2 is an exemplary embodiment of the latching system of the lockable door in closed configuration according to the present invention.

FIG. 3 illustrates an exemplary embodiment of the opposing latches and locking latch securing mechanism whereby the securing rod is deployed holding the locking latch in place.

FIG. 4 illustrates the locking latch securing mechanism while the locking latch is in an unlocked condition.

FIG. 5 depicts an exemplary embodiment of the securing rod, the securing block and the locking latch in a locked condition as the lockable door is opened.

FIG. 6 is a flow chart illustrating the process in which the self-locking lockbox is unlocked.

### DETAILED DESCRIPTION

Exemplary Embodiments are described herein in the context of a self-locking lockbox system. Those of ordinary skill in the art will realize that the following detailed description is illustrative only and is not intended to be in any way limiting. Other embodiments of the present invention will readily suggest themselves to such skilled persons having the benefit of the disclosure. Reference will now be made in detail to implementations of embodiments of the present invention as illustrated in the accompanying drawings. The same reference indicators will be used throughout the drawings and the following detailed description to refer to the same or like parts.

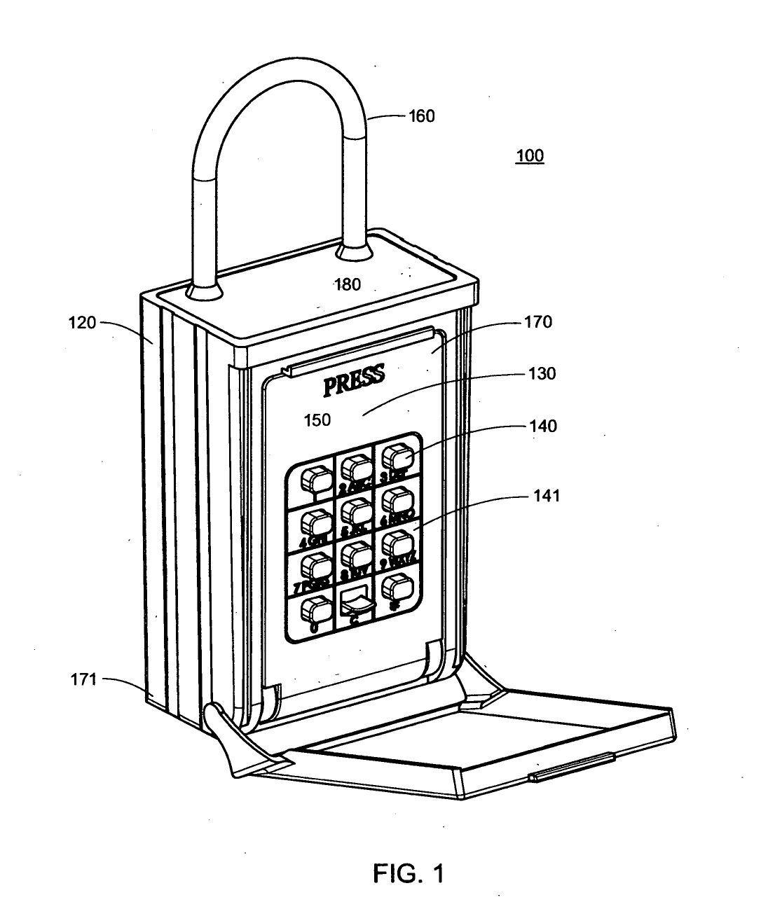

Referring to FIG. 1, an embodiment of self-locking lockbox (100) can generally be seen as including a body (120) and a lockable door (130). The lockable door having a latching system (not, shown) and a locking end (170) whereby the latching system is located at the locking end of the lockable door. The lockable door also includes a hinged end (1.71) whereby the hinged end (171) is rotatable and secured to the body of the self-locking lockbox. The lockable door includes a combination locking mechanism (140) which is located towards the hinged end (171) and a flat surface (150) located towards the locking end (170) whereby the flat surface (150) enables a surface whereby a user may push the locking end (170) to unlock and open the lockable door (130) after entering their combination.

In this embodiment of the invention, attachment bail (160) is U-shaped and extends away from the top surface (170) of the body (120). Attachment bail (160) is slidable from a first open position to a second closed position in which lockbox (100) can be secured to a building structure. As with other conventional combination padlocks, combination locking mechanism (141) and key locks can be used to secure attachment bail (160) to body (120) in the closed position.

Additionally, in the present embodiment where the combination lock mechanism (140) includes a mechanical keypad (141) a user may input a combination to initiate the unlocking process.

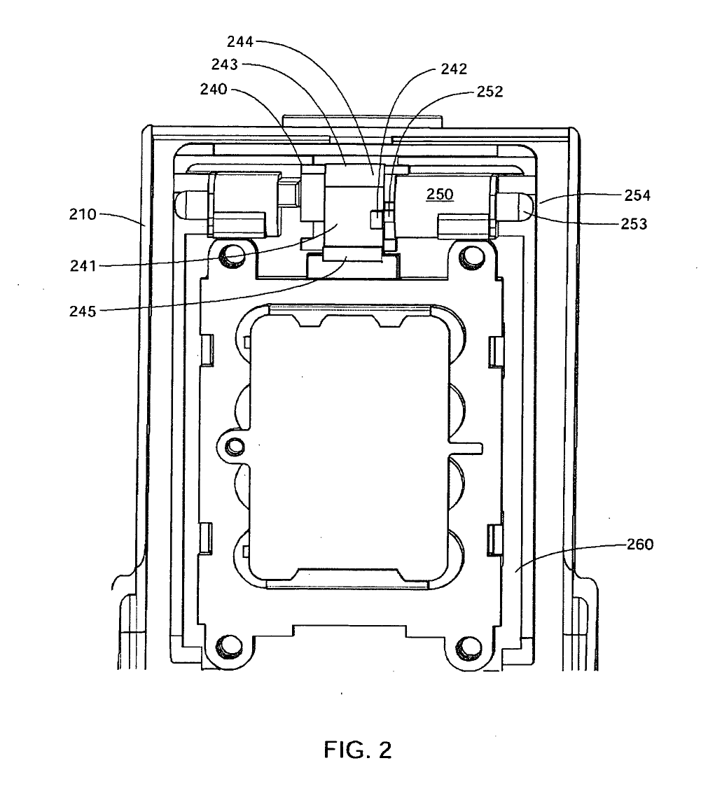

Referring now to FIG. 2, which illustrates the rear view of the lockable door (210), as if it was in the closed and locked configuration within the body and includes a latching system (240), and locking latch securing mechanism (250). Additionally, the latching system (240) includes a locking latch (241) that has a securing block (242) whereby the securing block (242) is a part of or fixed to the locking latch (241). The securing end (244) of the locking latch (241) has a beveled edge (243) and a flat edge (not-shown) such that, among other things, when closing the lockable door (210) the beveled edge (243) causes to the locking latch (241) to slide towards the hinged end (260) of the lockable door (210) enabling the locking, latch (241) along with the lockable door (210) ingress to the body (not shown) as it clears the locking plate (not shown). The opposite side of the securing end (244) is the attaching end (245) which is designed to attach to a combination locking mechanism such that when a combination is correctly entered into the combination locking mechanism the locking latch (243) is free to slide towards the hinged end (260) of the lockable door (210).

The locking latch securing mechanism (250) is another particularly innovative aspect of the present invention as embodied in FIG. 2, where the locking latch securing mechanism (250) is attached to the lockable door (210) and includes a securing rod (253) that extends outwardly on each side of locking latch securing mechanism (250) where the securing end (252) of the securing rod extends towards the locking latch (241) and the referencing end (253) of the securing rod extends towards a wall of the body (254). The locking latch securing mechanism (250) is configured such that when in closed configuration the referencing end (253) of the securing rod is spring operably compressed into the locking latch securing mechanism (251) by the body wall (254) thereby placing lateral force towards the securing end (252) of the securing rod. The securing end (252) of the securing rod is configured such that a spring operably caries the lateral pressure to the securing end (252) of the securing rod causing pressure between the securing end (252) and the securing block (242).

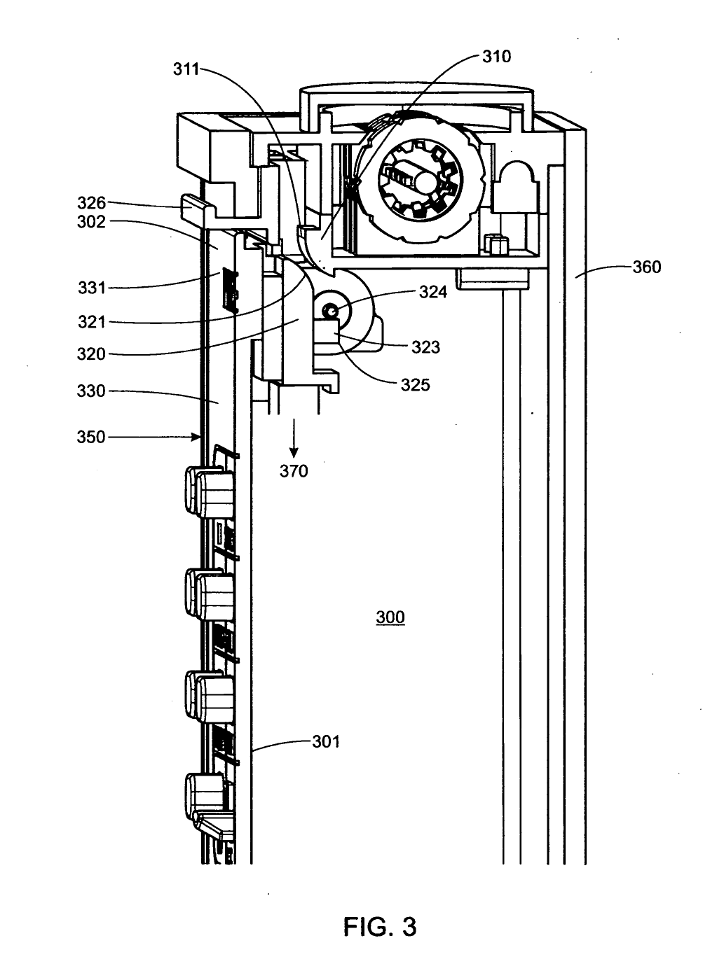

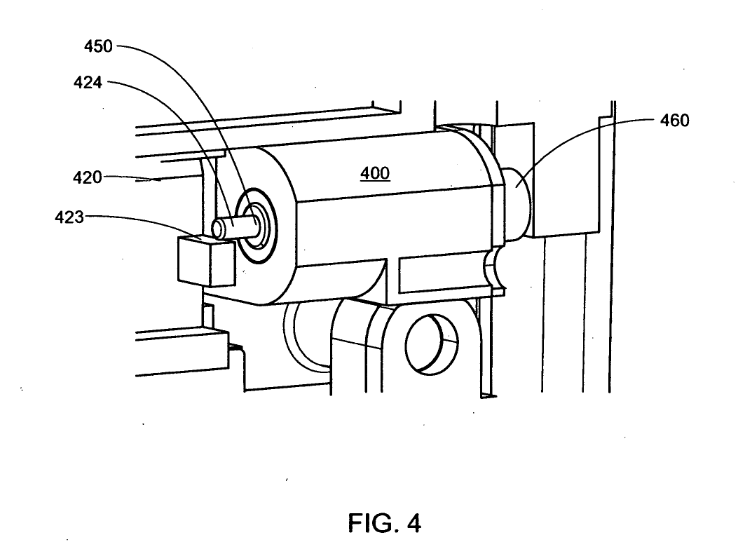

Providing a driving latch (310) is another important aspect of the present invention as embodied and represented in FIG. 3. The driving latch (310) also includes a beveled edge (311) and is securely fastened to the body (360) of the self-locking lockbox. The beveled edge (311) of the driving latch (310) counter opposes the beveled edge of the locking latch (320). While opening the self-locking lockbox, the beveled edge (311) of the driving latch (310) makes contact with the beveled edge (321) of the locking latch (320). Additionally, as a user pushes the flat surface (330) of the lockable door (331), subsequent to entering the correct combination, they generate a lateral force (350) that drives the beveled edge (320) of the locking latch (320) into the beveled edge (311) of the driving latch (310). Since the driving latch (310) is securely fastened to the body (360) and counter opposed, the beveled edges of the opposing latches translated the lateral force (350) into a vertical force (370) such that they overcome the counter spring force generated by the locking latch spring (not shown) configured to keep the locking latch (320) at the locking end (302) and in a locked condition and thereby driving the locking latch (320) to slide toward the hinged end (301) of the lockable door (331). Upon the locking latch (320) sliding at a distance whereby the locking latch (322) clears the securing plate (326), the securing block (323) is spaced such that the securing end (324) of the securing rod clears the one side of the securing block (323). As represented further in FIG. 4, once the securing end (410) of the securing rod (450) clears the one side of the securing block (430), by spring force the securing rod extends further and above the securing block (420) thereby restricting the securing block (420) and the locking latch from sliding back towards the locking end (FIG. 3: 302) of the lockable door (FIG. 3: 331).

As further represented in FIG. 4, the securing rod extends further and above the securing block (420) by way of spring force which is created by a common die spring (not shown) that resides within the locking latch securing mechanism (400). The base of the die spring is relationally connected to the compressed referencing end (460) of the securing rod (450). Upon releasing the compressed referencing end (460) of the securing rod (450) the locking latch securing mechanism is designed such that the spring force of the referencing end (460) of the securing rod (450) will overcome the spring force of the securing end (410) of the securing rod (450) thereby retracting the securing end (410) away from the securing block (410) such that the securing block (420) and the locking latch (not shown) is no longer restricted from sliding back towards the locking end of the lockable door.

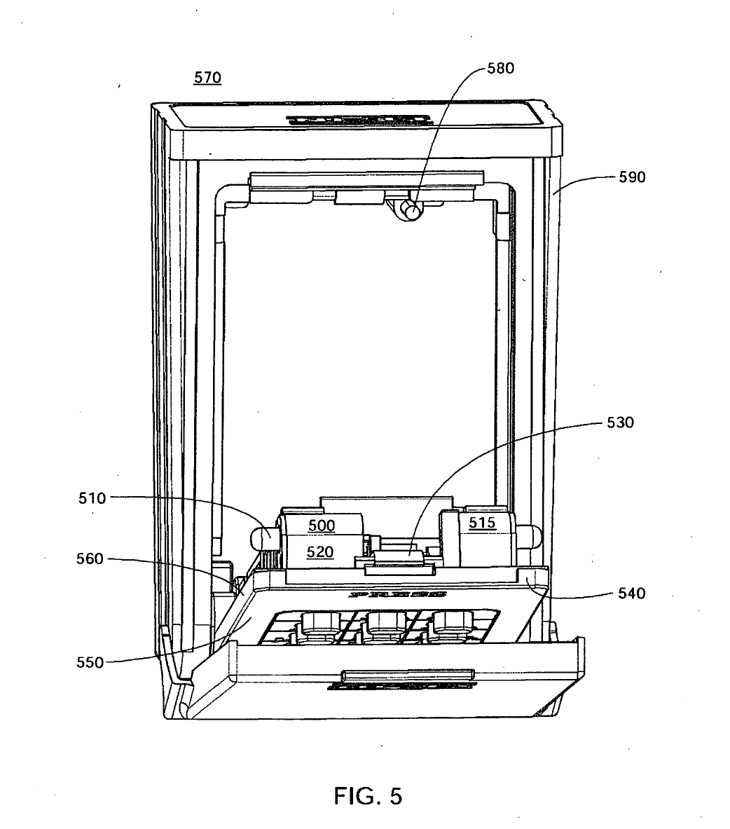

As represented in FIG. 5, in an open configuration, the released compressed referencing end (510) of the locking latch securing mechanism (500), releases the locking latch. (530) such that the locking latch (530) slides towards the locking end (540) of the lockable door (560) such that it is prepared to lock upon closing the lockable door (560) of the self-locking lockbox (570) such that additional locking action is not required by the user to lock the self-locking lockbox when closed. Additionally, an opening pin (580) provided at the upper end (590) of the body (570) and is designed to provide a spring force in an opening direction such that the force assists in the opening of the lockable door (560). Furthermore, the referencing end (510) of the locking latch securing mechanism (500) is rounded such that when closing the lockable door (560) the rounded referencing end enables the compression of the referencing end (510) of the securing rod (515).

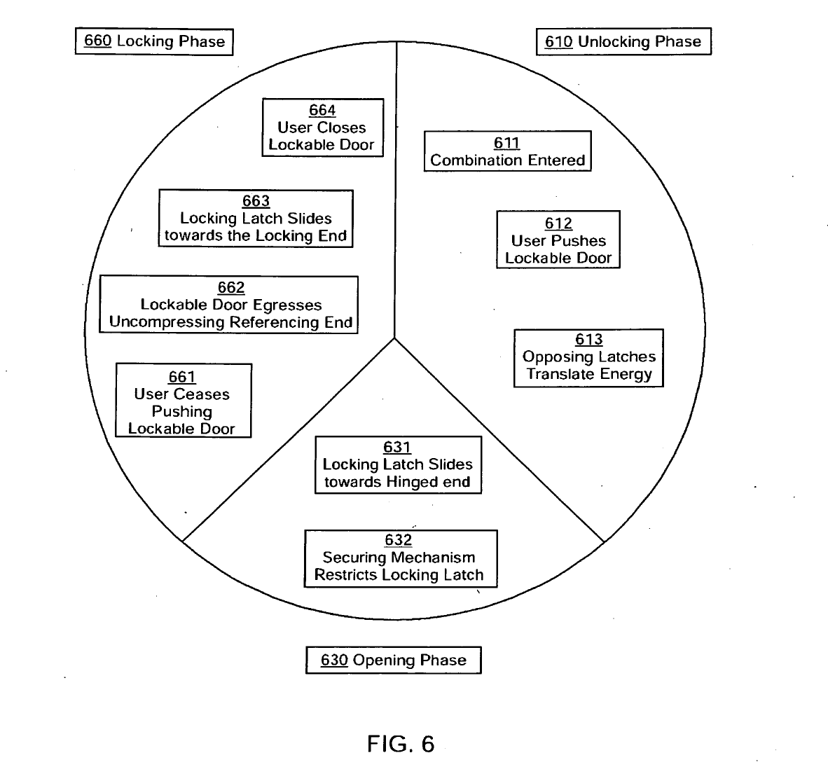

The flowchart in FIG. 6 is an embodiment of the process in which the apparatus described in FIG. 1 through FIG. 5 are used whereby the self-locking lockbox, self-locks. The process within the flowchart represents three phases, unlocking phase, opening phase and locking phase and assumes the lockbox is already in closed and locked condition and is meant to represent the process wherein the self-locking lockbox is opened and then closed by a user where the self-locking lockbox locks. The process includes unlocking the lockbox, opening the lockbox and then closing the lockbox.

The first phase of the process as embodied in FIG. 6 is the unlocking phase. The unlocking phase consists of the user entering the combination into the combination locking mechanism (611). The user then pushes on the lockable door (612) which drives the locking latch into the driving latch and translating the energy (613) from a lateral force into a vertical force.

The opening phase of the process is the next phase whereby the translated force drives the locking latch to slide towards the hinged end (631) thereby enabling it to clear the locking plate which is designed to restrict the door from opening. The sliding of the locking latch causes the securing block to slide enabling the securing mechanism to restrict locking latch from sliding towards the locking end.

The next phase of the process includes the user ceasing to push the lockable door and with the assistance of the opening pin the locking end of the lockable door travels away from the body. This travel causes the referencing end of the securing mechanism to uncompress as the lockable door egresses past the wall of the body. As the referencing end uncompresses it retracts the securing end securing mechanism thereby allowing the locking latch to travel back to the locking end of the lockable door once the locking latch clears the locking plate. The traveling of the locking plate back to the locking end of the lockable door places the locking latch back into locking condition.

As the user closes the lockable door the beveled edge of the locking plate drives the locking lever to slide down towards the hinged end of the lockable door such that the lockable lever clears the locking plate but does not clear enough to enable the securing end of the securing mechanism to extend. Once the locking latch clears the locking plate it returns back towards the locking end of the lockable door thereby causing the door to be closed and locked and additional locking action was not required by the user to lock the lockable self-locking lockbox.

The foregoing description of preferred embodiments of the present invention has been provided for the purposes of illustration and description. It is not intended to be exhaustive of to limit the invention to the precise forms disclosed. Many embodiments were chosen and described in order to best explain the principles of the invention and its practical application, thereby enabling others skilled in the art to understand the invention for various embodiments and with various modification that are suited to the particular use contemplated. It is intended that the scope of the invention by defined by the claims and their equivalents.

1. A locking lockbox with a lockable door, the locking lockbox comprising:
a latching system, for closing the locking lockbox; and
a combination locking mechanism, wherein reentry of a combination is not required for closing and locking the locking lockbox, when opened.

2. The locking lockbox of claim 1, wherein the latching system comprises of a locking latch with a beveled edge.

3. The locking lockbox of claim 1, wherein the combination locking mechanism is a mechanical pushbutton combination locking mechanism.

4. The locking lockbox of claim 1, further comprising:
a locking latch securing mechanism for securing the latching system.

5. The locking lockbox of claim 1, wherein the latching system further comprises of a securing rod for securing the locking latch, when opened.

6. A method of locking a locking a locking lockbox, the method comprising of:
unlocking a locking lockbox by entering a combination on a mechanical keypad;
opening a locking lockbox; and
closing and locking a locking lockbox,
wherein reentry of the combination is not required for closing and locking the locking lockbox.

7. A method of claim 6, wherein unlocking the locking lockbox includes entering a combination into a mechanical pushbutton keypad and pushing a lockable door to open.

8. (canceled)

9. (canceled)

10. (canceled)

11. (canceled)

12. (canceled)

13. (canceled)

14. (canceled)
